(19) United States
(12) Patent Application Publication
(10) Pub. No.: US 2005/0149256 A1
(43) Pub. Date: Jul. 7, 2005

(54) Device for determining the position by means of fixed and/or variable landmarks

(75) Inventors: Gisbert Lawitzky, Munich (DE); Bernhard Ober, Erlangen (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/984,871

(22) Filed: Nov. 10, 2004

Related U.S. Application Data
(63) Continuation of application No. PCT/DE03/01371, filed on Apr. 29, 2003.

(30) Foreign Application Priority Data
May 10, 2002 (DE) 102 209 36.7

(51) Int. Cl. G01C 21/26

(52) U.S. Cl. 701/207; 701/200

(57) ABSTRACT

The invention relates to a device (1) for determining the position in an environment and for detecting and updating landmarks (5 and 6) by means of information data (3) describing the environment. The device has a navigation system (2) for detecting a specific position in the environment. Modifications of movable landmarks (5), which are made by the device (1), are registered by the device (1) and the information data (3) describing the environment is modified. The device (1) can exchange information data on the environment with a based unit (8) via transmission and receiver devices (7, 9, 10 and 11).

The invention relates to a device for determining a specific position and to an autonomous mobile system that includes such a device.

Autonomous mobile systems are used in publicly accessible areas, e.g., as service robots and cleaning robots. In block storage facilities, e.g., in the beverage industry, driverless transport vehicles are used. The position of such service robots or driverless transport vehicles in their respective environment can be determined by means of a navigation system. In addition to determining the position, the navigation system can indicate parameters, such as driving speed and driving direction. This information is used to control the service robot or the transport vehicle within its environment. To determine the position of the autonomous mobile system, the navigation system uses so-called landmarks, i.e., objects in the environment that can be uniquely identified by sensors of the autonomous mobile system. These landmarks are entered in a map known to the navigation system. As a rule, such a map is static and not subject to changes. The landmarks used are reflectors, transponders or beacons that are detected by corresponding sensors. In highly dynamic environments this may cause problems because fixed landmarks may be covered up, or it may not be possible to install them in such a way as to obtain adequate positioning quality in all positions.

German Patent DE 43 24 531 C1 discloses a method for generating an environmental map and for determining a specific position within the environment of a self-propelled unit, which uses natural objects of the environment for position fixing.

The object of the invention is to provide a device enabling simple updating of the data describing the environment used by the navigation system.

This object is attained by a device for determining a specific position. This device has a navigation system for determining a position relative to predefinable information data describing the environment, a memory for storing the information data, means for detecting changes in the environment relative to the information data and means for making changes in the information data and for generating new information data.

The invention is based on the recognition that in a highly dynamic environment an autonomous mobile system, e.g., a service robot or a driverless transport vehicle, must have a current map of the environment at all times. Natural landmarks for generating an environmental map and for determining a specific position are primarily movable objects, such as pallets, for example. These movable objects can be used for determining a position in addition to fixed landmarks, provided that their position in the environment can be determined with sufficient accuracy after a positional change. In block storage facilities, driverless transport vehicles or forklifts move such movable objects, e.g., pallets, from one position to another. In the process, the autonomous mobile systems involved continuously change the environment as a result of their own activities. For this reason it is advantageous if the systems can immediately and directly record the changes caused by the autonomous mobile systems themselves and if existing information data used for position fixing by a navigation system can be simultaneously updated. The updated information data are stored in the autonomous mobile system and are thus available at all times.

A particular advantage is that the device or the autonomous mobile system does not need any additional hardware to record and update positions of, e.g., movable objects (pallets, drums or beverage cases). This eliminates the need for installing reflectors, beacons or other items enabling the autonomous mobile system to orient itself in its environment.

One advantageous embodiment of the invention is characterized in that the information data describing the environment used by the navigation system for position fixing represent variable landmarks and/or fixed landmarks. The distinction between variable and fixed landmarks makes it possible to store certain landmarks that do not change as fixed constants in the memory, such that a defined framework can be predetermined within which the autonomous mobile system can orient itself and move.

A further advantageous embodiment of the invention is characterized in that the device has means for distinguishing between variable and fixed landmarks. This has the advantage that the device can directly detect which landmarks can and/or may be moved in the first place. This enables the device or the autonomous mobile system, for example, to communicate to the device via the entry or identification of variable landmarks in which environment the device should be active, i.e., which pallets or beverage cases it may independently move. This is advantageous, for example, if only special autonomous mobile systems may change the position of defined variable landmarks. In consignment systems and storage systems that handle different products, e.g., both refrigerated products and other food products that may have to be handled differently, a corresponding assignment to specific transport vehicles may be effected using warehouse management software.

A further advantageous embodiment of the invention is characterized in that the device has means for recording positional changes of variable landmarks made by the device. This enables the device to record the changes directly and to modify and store the information data describing the environment. No other systems involved are required to first tell the device or the autonomous mobile system that the environment has been changed. This makes it possible to achieve real-time updating, which is particularly important in a highly dynamic environment.

A further advantageous embodiment of the invention is characterized in that the device has a receiver for receiving data transmitted by a base unit to the device for entering variable landmarks. This makes it possible to transmit data, particularly changes in the information data describing the environment, from a base station to the device. The device then updates the transmitted data, i.e., the new information data are stored in the memory. This capability of transmitting data from a base station to the device makes it possible to supply a plurality of autonomous mobile systems with current data about the environment. It is feasible, for example, for an autonomous mobile system to transmit an update, i.e., the detection of changes in the information data and the generation of new information data, to the base station and for the base station to forward these data received from the first autonomous mobile system to all other autonomous mobile systems involved.

This ensures that all the autonomous mobile systems involved can be informed at any time about the current state of their environment. This is advantageous particularly in a warehouse, where a plurality of mobile robots or driverless transport vehicles simultaneously change the environment by moving objects or landmarks, i.e., units with products.

A further advantageous embodiment of the invention is characterized in that the device has a transmitter for transmitting updated positions of variable landmarks to the base unit. This enables each device involved, e.g., an autonomous mobile system, to transmit the updated information data to a base station. The advantage is that other devices involved can be immediately informed about current changes in the environment.

A further advantageous embodiment of the invention is characterized in that the information data describing the environment, which are used by the navigation system, are provided for display on a map. This manner of representing the information data makes it easier for an operator of a warehouse management system to get an overview of the spatial conditions, since people are visually oriented and as a rule are familiar with reading and interpreting maps. A corresponding user interface in a warehouse management system on which the map, including the autonomous mobile systems and landmarks are displayed, can be used to monitor the current situation in the respective environment. It is also advantageous to use such an interface to make changes in the map, e.g., to identify specific landmarks as “fixed” for certain autonomous mobile systems. Thus, the display enables central monitoring and operation.

A further advantageous embodiment of the invention is characterized in that the information data depicted on the map are provided directly on the device and/or on a base unit. The advantage is that large amounts of data that are generated when complex maps are created do not necessarily have to be stored directly on the device, i.e., for example, an autonomous mobile system or a transport vehicle, but can be stored in a central memory of a base unit. This is advantageous particularly in complex environments. Furthermore, central data storage and central updating of the information data used by the navigation system is advantageous if a plurality of autonomous mobile systems is active at the same time.

A further advantageous embodiment of the invention is characterized in that the device is provided for use in an autonomous mobile system, such as a mobile robot and/or a driverless transport vehicle. This ensures that the information data are up to date and makes it possible for the autonomous mobile system to move safely within its environment.

The invention will now be described and explained in greater detail with reference to exemplary embodiments depicted in the figures, in which:

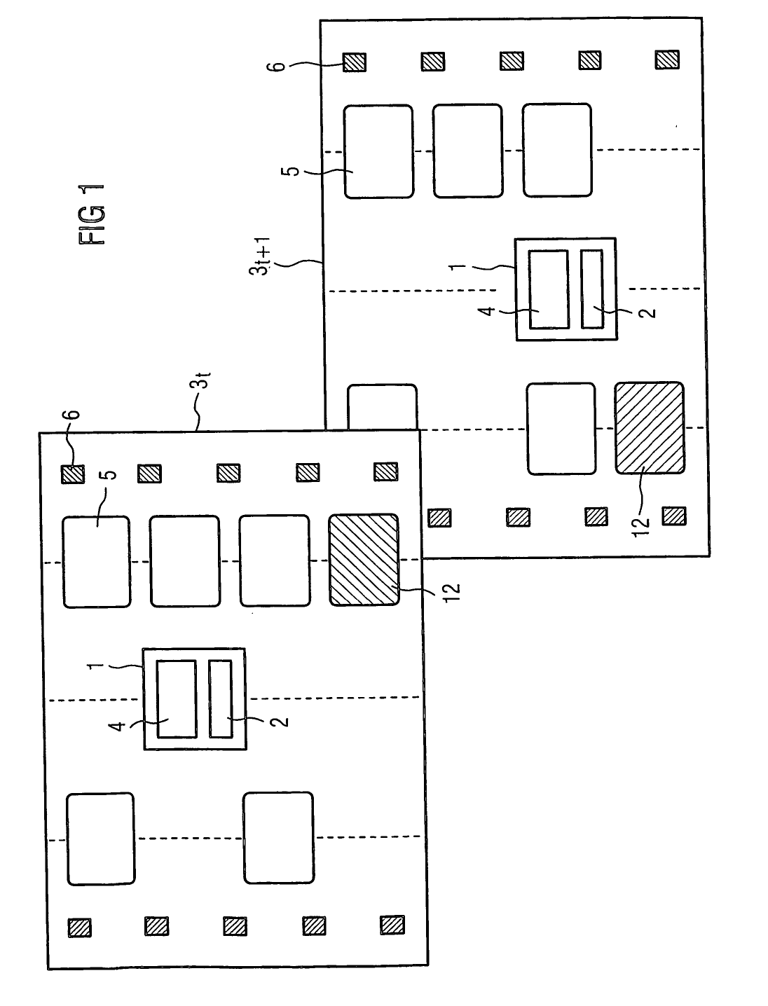

FIG. 1 is a schematic representation of an exemplary embodiment of the device for determining a specific position and information data describing the environment,

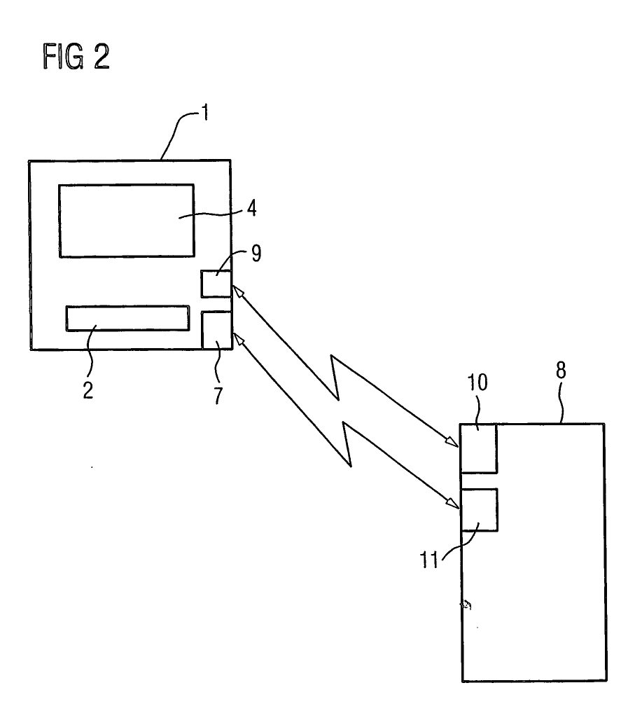

FIG. 2 is a schematic representation of a device having a transmitter and a receiver for exchanging data with a base unit.

FIG. 1 is a schematic representation of an exemplary embodiment of a device 1, e.g., an autonomous mobile system, which knows its current position within an environment relative to information data 3ₜ describing the environment through a device-internal navigation system 2. The device depicted in FIG. 1 consists of, among other things, a memory 4 for storing the information data 3ₜ and has essentially means for detecting changes in the information data 3ₜ, means for entering changes in the information data 3ₜ and means for generating new information data 3ₜ₊₁. The information data describing the environment represent variable landmarks 5 and fixed landmarks 6. Positional changes in the variable landmarks 12 made by the device 1 or by other autonomous mobile systems involved are recorded between the instant t and the instant t+1, and the newly generated information data 3ₜ₊₁ are stored in the memory 4.

The special feature of the device 1 depicted in FIG. 1 is essentially that the device 1 knows the position of variable landmarks 5 at all times based on the information data 3ₜ describing the environment. Any positional changes in the variable landmarks 5 are detected, and new information data 3ₜ₊₁ are generated and stored in the memory 4. The device 1 knows its own position relative to the information data 3ₜ at all times by means of the navigation system 2, and the current situation in the environment is known to the device 1 based on the generation of new information data 3ₜ₊₁. This is advantageous in highly dynamic environments, e.g., in beverage warehouses. An essential advantage is that particularly changes in the landmarks made by the device 1 itself can be immediately updated in the information data 3ₜ at any time.

The device 1 can be, for example, a driverless transport vehicle that transports pallets in a warehouse from one position to another. At the instant t, a pallet with beverage cases 12 is located, for example, in the right row of a warehouse together with three other pallets, which are identified as variable landmarks 5. This status is stored in the information data 3ₜ. A driverless transport vehicle now picks up the pallet 12 and sets it down again on the left side of the warehouse, e.g., in the row for outgoing goods. The change is recorded and the information data 3ₜ₊₁ are updated.

FIG. 2 is a schematic representation of a device 1 with a navigation system 2 and a memory 4. The device 1 has a receiver 7 for receiving data that the base station 8 transmits to the device 1. The base station 8 is equipped with a transmitter 11 to transmit the data. Data can also be transmitted from the device 1 to the base station 8 by means of a transmitter 9. To receive the data, the base station 8 has a receive station 10.

The special feature of the embodiment of the device 1 depicted in FIG. 2 is essentially that the information data 3ₜ describing the environment which are stored in the memory 4 and the information data 3ₜ₊₁ of variable landmarks 5 which are newly generated after a change can be transmitted to a base station 8. The base station 8 can be a server which stores relatively large amounts of data and which can optionally transmit these data to a plurality of devices. This makes it possible, for example, to simultaneously supply a plurality of autonomous mobile systems with current information about their environment. The devices 1, e.g., driverless transport vehicles, present in a defined environment can supply a current map of their environment based on their information data 3ₜ at any time, and these maps can be transmitted to the base station 8. The base station 8 can then transmit the collected updates back to the respective autonomous mobile systems or the devices 1 involved. This makes it possible in a beverage warehouse, for example, to supply a plurality of driverless transport vehicles with a current “picture” of their environment at any time. In addition, the information data can be entered on a map at the base station on which an operator can monitor the environment by means of a suitable interface and can optionally also make changes in the information data, e.g., by changing the status of variable landmarks 5 to fixed landmarks 6. This enables central monitoring and control in a warehouse management system.

In summary, the invention relates to a device 1 for determining the position in an environment and for establishing and updating landmarks 5 and 6 by means of information data 3 describing the environment. The device has a navigation system 2 for determining a specific position in the environment. Any changes that the device 1 makes in the variable landmarks 5 are recorded by the device, and the information data 3 describing the environment are changed. The device 1 can exchange information data about the environment with a base unit 8 via transmitters and receivers 7, 9, 10 and 11.

1. Device for determining a specific position, wherein the device (1) has
a navigation system (2) for determining the position relative to predefinable information data (3ₜ) describing the environment,
a memory (4) for storing the information data (3ₜ),
means for detecting changes in the environment relative to the information data (3ₜ), and
means for entering changes in the information data (3ₜ) and for generating new information data (3ₜ₊₁).

2. Device as claimed in claim 1, characterized in that
the information data (3ₜ) describing the environment, which are used by the navigation system (2) for determining the position, represent variable landmarks (5) and/or fixed landmarks (6).

3. Device as claimed in claim 1 or 2, characterized in that
the device (1) has means for distinguishing variable landmarks (5) from fixed landmarks (6).

4. Device as claimed in any one of claims 1 to 3, characterized in that
the device (1) has means for recording positional changes of variable landmarks (5) that are made by the device (1).

5. Device as claimed in any one of claims 1 to 4, characterized in that
the device (1) has a receiver (7) for receiving data transmitted by means of a base unit (8) to the device (1) for entering variable landmarks (5).

6. Device as claimed in any one of claims 1 to 5 characterized in that
the device (1) has a transmitter (9) for transmitting updated positions of variable landmarks (5) to the base unit (8).

7. Device as claimed in any one of claims 1 to 6 characterized in that
the information data (3ₜ) describing the environment, which are used by the navigation system (2), are provided for display on a map.

8. Device as claimed in any one of claims 1 to 7 characterized in that
the information data (3ₜ) depicted on the map are provided directly on the device (1) and/or on a base unit (8).

9. Device as claimed in any one of claims 1 to 8 characterized in that
the device (1) is provided for use in an autonomous mobile system, such as a mobile robot and/or a driverless transport vehicle.

10. Autonomous mobile system having a device as claimed in any one of claims 1 to 9.
